(19) United States
(12) Patent Application Publication
(10) Pub. No.: US 2017/0154651 A1
(43) Pub. Date: Jun. 1, 2017

(54) METHOD FOR PRESENTING VIDEO SEGMENTS AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Lina ZHANG, Beijing (CN); Shibin LI, Beijing (CN)

(21) Appl. No.: 15/247,800

(22) Filed: Aug. 25, 2016

Related U.S. Application Data
(63) Continuation of application No. PCT/CN2016/089085, filed on Jul. 7, 2016.

(30) Foreign Application Priority Data
Dec. 1, 2015 (CN) 201510866733.8

(51) Int. Cl. G11B 27/00; G11B 27/10; H04N 5/92; G11B 27/02

(52) U.S. Cl. CPC G11B 27/002; G11B 27/02; G11B 27/102; H04N 5/92

(57) ABSTRACT

Embodiments of the present disclosure disclose a method and a system for presenting a video segment, wherein the method includes: for an online video, determining playing starting time of an effective video segment according to occurrence time of video comments and the number of occurrences of the video comments during playing of the online video; obtaining the effective video segment according to the playing starting time of the effective video segment and a playing duration; presenting the effective video segment in a video segment list of the online video.

### CROSS-REFERENCE TO RELATED APPLICATIONS

The present disclosure is a continuation of International Application No. PCT/CN2016/089085, with an international filing date of Jul. 7, 2016, which is based upon and claims priority to Chinese Patent Application No. 201510866733.8, filed on Dec. 1, 2015, and the entire contents of all of which are incorporated herein by reference.

### FIELD OF TECHNOLOGY

Embodiments of the present disclosure relates to the technical field of Internet, and in particular, to a method and for presenting video segments and an electronic device.

### BACKGROUND

In recent years, with rapid video-based social communication development, traditional interactive elements, such as text, image, voice and the like, it has been difficult to satisfy the social communication needs. The video capable of presenting more contents is now becoming popular. Video playing based on social comments is the content on which users mostly focus while watching online videos.

At present, there already exists a video-based social function. That is, when a user watches an online video, the user may enter text comments on the online video. As for video content having numerous user comments or triggering comparatively more topics, such video content is extremely attractive to other users, and the other users thus would very much like to view it. However, only two relatively complex operating modes are developed at present: (1) it requires the user to manually adjust the progress bar of the online video, and drags the progress bar to an appropriate position to watch a video segment. Nevertheless, it has a high request on the operation accuracy to manually adjust the progress bar, and the users needs to determine whether the current video segment is the target video segment while dragging the progress. (2) An online video is usually preset with a segment of highlights, but the preset segment of highlights always fails to attract users to gossip. The two above modes do not satisfy the user's need on playing the video segment quickly and exactly.

### SUMMARY

Embodiments of the present disclosure disclose a method and a system for presenting video segments to solve the problem that existing video segment playing modes have a high request on the accuracy of user's manual operation, and are unable to accurately satisfy the user's need.

An embodiment of the present disclosure discloses a method for presenting video segments, including: for an online video, determining playing starting time of an effective video segment according to occurrence time of video comments and the number of occurrences of the video comments during playing of the online video; obtaining the effective video segment according to the playing starting time of the effective video segment and a playing duration of the effective video segment; presenting the effective video segment in a video segment list of the online video.

Correspondingly, an embodiment of the present disclosure further discloses an electronic device, including at least one processor; and a memory communicably connected with the at least one processor for storing instructions executable by the at least one processor, wherein execution of the instructions by the at least one processor causes the at least one processor to:
for an online video, determine playing starting time of an effective video segment according to occurrence time of video comments and the number of occurrences of the video comments during playing of the online video;
obtain the effective video segment according to the playing starting time of the effective video segment and a playing duration of the effective video segment;
present the effective video segment in a video segment list of the online video.

An embodiment of the present disclosure discloses a computer program, comprising computer-readable codes, wherein when the computer-readable codes are run on a server, the server is led to execute the method for presenting video segments above.

An embodiment of the present disclosure discloses a non-transitory computer readable medium, storing executable instructions that, when executed by an electronic device, cause the electronic device to: for an online video, determine playing starting time of an effective video segment according to occurrence time of video comments and the number of occurrences of the video comments during playing of the online video; obtain the effective video segment according to the playing starting time of the effective video segment and a playing duration of the effective video segment; present the effective video segment in a video segment list of the online video.

### BRIEF DESCRIPTION OF THE DRAWINGS

In order to more clearly illustrate the technical solutions in the embodiments of the present disclosure, accompanying drawings needing to be used in the embodiments will be introduced below briefly. Apparently, the accompanying drawings in the descriptions below are some embodiments of the present disclosure, and for a person skilled in the art, other drawings may also be obtained according to the accompanying drawings without creative work.

FIG. 1 is a step flow diagram of a method for presenting video segments in some embodiments of the present disclosure.

FIG. 2 is a step flow diagram of a method for presenting video segments in a some embodiments of the present disclosure.

FIG. 3 is a structural schematic diagram of a system for presenting video segments in some embodiments of the present disclosure.

FIG. 4 schematically shows a block diagram of an electronic device for executing a method according to some embodiments of the present disclosure; and

FIG. 5 schematically shows a storage unit for holding or carrying program codes for executing a method according to some embodiments of the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure rather than all. On the basis of the embodiments in the present disclosure, all the other embodiments obtained by a person skilled in the art without creative work should fall into the scope of protection of the present disclosure.

A method for presenting video segments provided by some embodiments of the present disclosure will be introduced below in detail. The method is applied to a server.

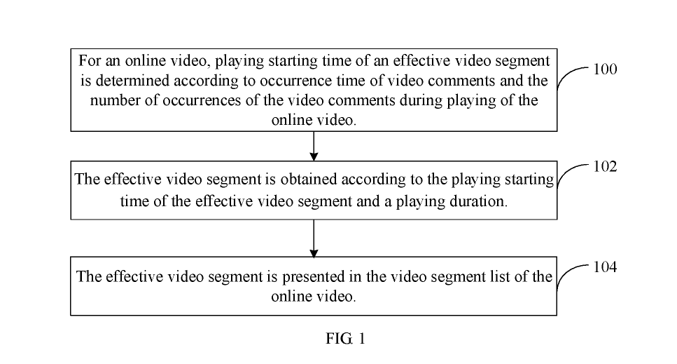

Referring to FIG. 1, shown therein is the step flow diagram of the method for presenting video segments in the first embodiment of the present disclosure.

In step 100, for an online video, playing starting time of an effective video segment is determined according to occurrence time of video comments and the number of occurrences of the video comments during playing of the online video.

The occurrence time of the video comments may be time of playing of the online video when the video comments are entered by users; the time is a time point or a time period during playing of the online video. For example, provided that a total playing duration of a certain online video is 45 minutes, if a video comment is entered by a user when the online video is playing at the 25^{th} minute, the occurrence time of the video comment is at the 25^{th} minute.

The number of occurrences of the video comments can be the number of the video comments. If the number of the video comments entered at the occurrence time of the video comments is low, a video segment playing when the video comments are entered is a non-effective video segment. When the number of the video comments entered at certain occurrence time of the video comments reaches a certain threshold value, a video segment playing when the video comments are entered is the effective video segment. Specifically, the certain threshold value may be set according to actual conditions.

In step 102, the effective video segment is obtained according to the playing starting time of the effective video segment and a playing duration of the effective video segment.

Playing end time of the effective video segment can be determined according to the playing starting time of the effective video segment and a preset playing duration, wherein the preset playing duration may be set according to actual conditions.

In step 104, the effective video segment is presented in the video segment list of the online video.

In a certain online video, a plurality of effective video segments may be obtained, and the plurality of obtained effective video segments are presented in the video segment list of the online video for users to select for playing.

In conclusion, according to the technical solution in this embodiment of the present disclosure, to any online video having a comment entering function, when the online video is played, each comment entered by a user is a comment on a certain video segment of the online video. The playing starting time of the effective video segment is determined according to the occurrence time of the video comments and the number of occurrences of the video comments, and then the effective video segment is obtained according to the playing starting time of the effective video segment and the preset playing duration, and presented in the video segment list of the online video. After the playing starting time of the effective video segment and the preset playing duration are obtained, it can be determined from when the effective video segment is started to when it is finished. Finally, the effective video segment is determined according to the playing starting time and the playing duration, and the obtained effective video segment is presented in the video segment list of the online video for users to select for playing. Therefore, the operation of a user manually dragging the progress bar to select the video segment is avoided; moreover, the video segment selected according to the user comments is more suitable for the watching needs of users.

A method for presenting a video segment provided by some embodiments of the present disclosure will be introduced below in detail. The method is applied to a server.

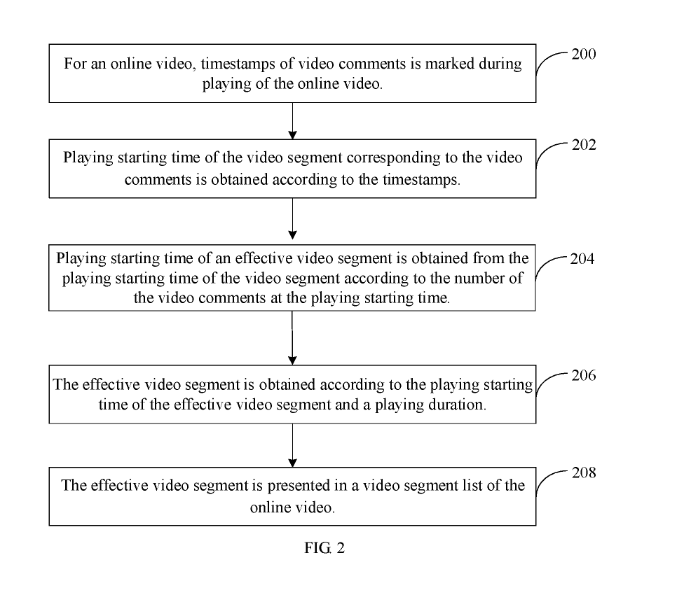

Referring to FIG. 2, shown therein is the step flow diagram of the method for presenting a video segment in the second embodiment of the present disclosure.

In step 200, for an online video, timestamps of video comments are marked during playing of the online video.

The video segment involved in this embodiment of the present disclosure is a video segment of the online video, and the video comment entered by a user is comment entered by the user while watching the online video, i.e., during playing of the online video.

During playing of the online video, the user can enter the comment on the online video via a comment entering system. The timestamp of the video comment entered by the user is the information of a playing time point of the online video when the video comment is entered by the user. For example, provided that a total playing duration of the online video is 45 minutes, if the online video is playing at the 25^{th} minute when the video comment is entered by the user, the timestamp of the video comment is at the 25^{th} minute.

It needs to be noted that in this embodiment of the present disclosure, the operation of the user entering the comment is identified by an operation that the user begins entering the comment, rather than an operation that the user finishes entering the comment and submits the comment.

In step 202, playing starting time of a video segment corresponding to the video comment is obtained according to the timestamps.

Due to a time gap between the time when the user enters the comment and the time when the user watches the video segment, i.e., resulting from that the user watches the video segment first and then enters the comment on the watched video segment, preset time is provided, and the playing time of the video segment corresponding to the comment is determined according to the timestamp of the comment and the preset time. Specifically, the timestamp is subtracted by the preset time to obtain the playing starting time of the video segment corresponding to the video comment, wherein the preset time may be n second(s); n is greater than or equal to 0.

For example, if the preset time is 5 seconds and the timestamp of a certain video comment is at the 25^{th} second of the 25^{th} minute, the playing time of the video segment corresponding to the video comment is at the 20^{th} second of the 25^{th} minute.

In step 204, playing starting time of an effective video segment is obtained from the playing starting time of the video segment according to the number of the video comments at the playing starting time.

In this embodiments of the present disclosure, when the number of the video comments corresponding to the playing starting time of the video segment is greater than a preset number, the video comments corresponding to the playing starting time of the video segment may be regarded as effective video comments. For example, the preset number is 50, which is not specifically limited in this embodiment of the present disclosure and which also may be set according to actual conditions. If the number of the video comments corresponding to the time at the 20^{th} second of the 25^{th} minute is 60, the time at the 20^{th} second of the 25^{th} minute can be determined as the playing starting time of the effective video segment.

In step 206, the effective video segment is obtained according to the playing starting time of the effective video segment and a playing duration of the effective video segment.

Specifically, the playing duration is a preset duration, or a preset proportion of a total duration of the online video.

For example, if the preset time is 1 minute, the playing duration of the effective video segment is determined as 1 minute. It needs to be noted that the preset duration may be determined according to relevant information of the online video, such as a type of the online video, a total duration and so on. The type of the online video may be film, TV series, animation, documentary film or the like.

The preset proportion is a portion of the playing duration of the effective video segment to the total duration of the online video. The preset proportion is multiplied by the total duration of the online video to obtain the playing duration of the effective video segment.

For example, provided that the preset proportion is 1/9 and the total playing duration of the online video is 45 minutes, the playing duration of the effective video segment may be 5 minutes.

In addition to the above way that the playing duration of the effective video segment is determined, other ways may also be utilized, for example, by use of an interval of video comments. The interval of the video comments refers to a time interval between a prior set of video comments and a posterior set of video comments. The prior set of video comments is for one video segment, while the posterior set of video comments is for another video segment. Moreover, no any other set of video comments exists between the prior set of video comments and the posterior set of video comments. When the number of video comments for a video segment reaches a certain threshold value, the video comments for the video segment are regarded as a set.

In step 208, the effective video segment is presented in a video segment list of the online video.

After all effective video segments of the online video are obtained, all the effective video segments may be saved in the video segment list of the online video; when any effective video segment therein is selected by a user, the selected effective video segment is played. Alternatively, the playing starting time and the playing durations of all the effective video segments may be saved in the video segment list of the online video; when any one effective video segment therein is selected by a user, the correspondingly video content in the online video is played according to the playing starting time and the playing duration of the selected effective video segment.

In conclusion, according to the technical solution in this embodiment of the present disclosure, to any online video having a comment entering function, when the online video is played, the time when a user enters a comment on the online video is the timestamp of the video comment. The timestamp of each comment on the online video entered by each user is marked; each comment is the comment on a certain video segment of the online video. Due to a time gap between the time when the user enters the comment and the time when the user watches the video segment, i.e., resulting from that the user watches the video segment first and then enters the comment on the watched video segment, the preset time is provided, and the playing time of the video segment corresponding to the comment is determined according to the timestamp of the comment and the preset time. Further, the playing starting time satisfying a preset condition is determined as the playing starting time of the effective video segment, and then the playing duration of the effective video segment is determined according to the preset duration; alternatively, the playing duration of the effective video segment is determined according to the preset proportion and the total duration of the online video. After the playing starting time of the effective video segment and the preset playing duration are obtained, it can be determined from when the effective video segment is started to when it is finished. Finally, the effective video segment is determined according to the playing starting time and the playing duration, and the obtained effective video segment is presented in the video segment list of the online video for users to select for playing. Therefore, the operation of a user manually dragging the progress bar to select the video segment is avoided; moreover, the video segment selected according to the user comments is more suitable for the watching needs of users.

A system for presenting a video segment provided by some embodiments of the present disclosure will be introduced below in detail. The system is applied to a server.

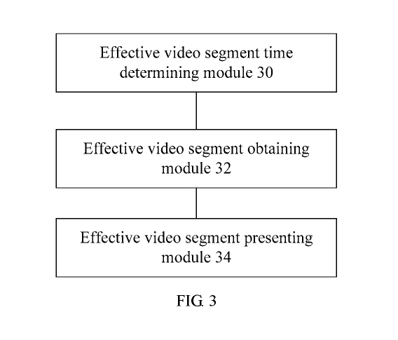

Referring to FIG. 3, shown therein is the structural schematic diagram of the system for presenting a video segment in the third embodiment of the present disclosure.

The system may include: an effective video segment time determining module 30, an effective video segment obtaining module 32, and an effective video segment presenting module 34.

Functions of the modules and relations thereof will be separately introduced below in detail.

The effective video segment time determining module 30 is used for, to an online video, determining playing starting time of an effective video segment according to occurrence time of video comments and a number of occurrences of the video comments during playing of the online video.

The effective video segment obtaining module 32 is used for obtaining the effective video segment according to the playing starting time of the effective video segment and a playing duration, wherein the playing duration is a preset duration, or a preset proportion of a total duration of the online video.

The effective video segment presenting module 34 is used for presenting the effective video segment in a video segment list of the online video.

Optionally, the effective video segment time determining module 30 may include a marking module, a first time determining module, and a second time determining module. Specifically, the marking module is used for, to an online video, marking a timestamp of a video comment.

The first time determining module is used for obtaining playing starting time of a video segment corresponding to the video comment according to the timestamp.

The second time determining module is used for obtaining the playing starting time of the effective video segment from the playing starting time of the video segment according to the number of the video comments at the playing starting time.

Optionally, the first time determining module obtains the playing starting time of the video segment corresponding to the video comment by subtracting preset time from the timestamp, wherein the preset time may be n second(s); n is greater than or equal to 0.

In conclusion, according to the technical solution in this embodiment of the present disclosure, to any online video having a comment entering function, when the online video is played, the time when a user enters a comment on the online video is the timestamp of the video comment. The timestamp of each comment on the online video entered by each user is marked; each comment is the comment on a certain video segment of the online video. Due to a time gap between the time when the user enters the comment and the time when the user watches the video segment, i.e., resulting from that the user watches the video segment first and then enters the comment on the watched video segment, the preset time is provided, and the playing time of the video segment corresponding to the comment is determined according to the timestamp of the comment and the preset time. Further, the playing starting time satisfying a preset condition is determined as the playing starting time of the effective video segment, and then the playing duration of the effective video segment is determined according to the preset duration; alternatively, the playing duration of the effective video segment is determined according to the preset proportion and the total duration of the online video. After the playing starting time of the effective video segment and the preset playing duration are obtained, it can be determined from when the effective video segment is started to when it is finished. Finally, the effective video segment is determined according to the playing starting time and the playing duration, and the obtained effective video segment is presented in the video segment list of the online video for users to select for playing. Therefore, the operation of a user manually dragging the progress bar to select the video segment is avoided; moreover, the video segment selected according to the user comments is more suitable for the watching needs of users.

The system embodiment described above is merely schematic, wherein the units illustrated as separate components may be physically separated or not; components displayed as units may be physical units or not, which can be located at the same place or distributed to a plurality of network units. Part or all of the modules may be selected according to actual requirements to achieve the purposes of the solutions of the embodiments. A person skilled in the art can understand and implement the solutions without creative work.

According to the descriptions of the above embodiments, a person skilled in the art could clearly learn that the embodiments may be realized by means of software and a necessary general hardware platform, and of course, may also be realized by hardware. Based on such an understanding, the above technical solutions substantially or the part making contribution to the prior art may be embodied in the form of a software product, and the computer software product may be stored in a computer-readable storage medium, such as an ROM/RAM, a magnetic disk, an optical disk, or the like, which includes a plurality of commands for enabling computer equipment (which may be a personal computer, a server, network equipment, or the like) to execute each embodiment or methods mentioned in some parts of the embodiments.

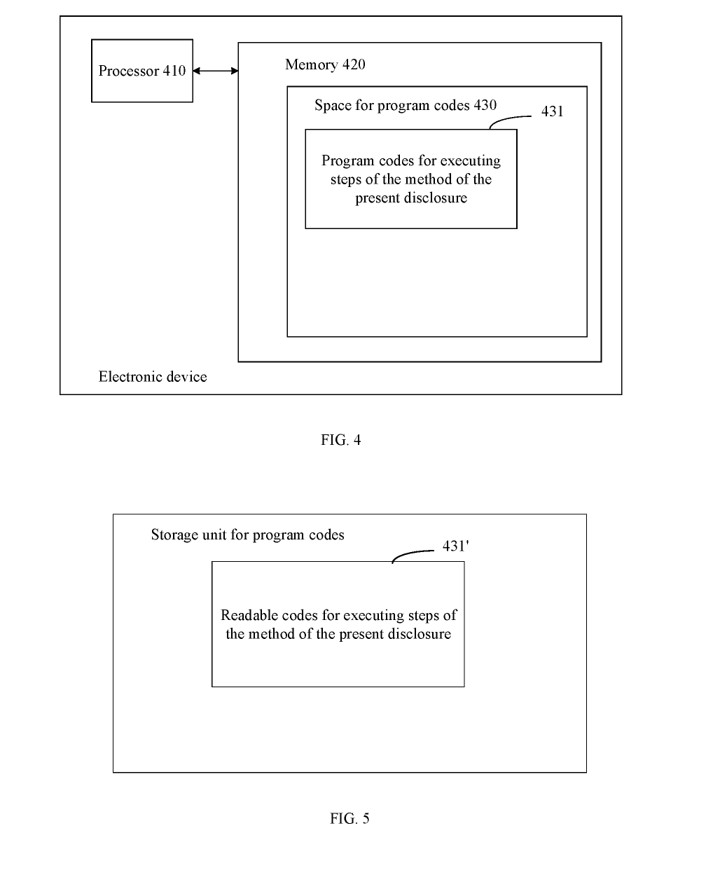

For example, FIG. 4 illustrates a block diagram of an electronic device for executing the method according the disclosure. The electronic device may be the server above. Traditionally, the electronic device includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which can be read for example by processors 410. When these codes are operated on the electronic device, the electronic device may execute respective steps in the method as described above.

Finally, it should be noted that the above embodiments are merely used for illustrating, rather than limiting, the technical solutions of the present disclosure. Although the present disclosure is described in detail with reference to the aforementioned embodiments, it should be understood by a person skilled in the art that modifications may still be made to the technical solutions described in the aforementioned embodiments, or equivalent alternatives may be applied to part of the technical features therein; these modifications or alternatives do not cause the nature of the corresponding technical solutions to depart from the spirit and the scope of the technical solutions in the embodiments of the present disclosure.

What is claimed is:

1. A method for presenting video segments, comprising:
at a server;
for an online video, determining playing starting time of an effective video segment according to occurrence time of video comments and the number of occurrences of the video comments during playing of the online video;
obtaining the effective video segment according to the playing starting time of the effective video segment and a playing duration of the effective video segment;
presenting the effective video segment in a video segment list of the online video.

2. The method according to claim 1, wherein the determining the playing starting time of the effective video segment according to the occurrence time of the video comments and the number of occurrences of the video comments during playing of the online video comprises:
marking timestamps of the video comments;
obtaining playing starting time of the video segment corresponding to the video comments according to the timestamps;
obtaining the playing starting time of the effective video segment from the playing starting time of the video segment according to the number of the video comments at the playing starting time.

3. The method according to claim 2, wherein the obtaining the playing starting time of the video segment corresponding to the video comments according to the timestamps comprises:
subtracting the timestamps by preset time to obtain the playing starting time of the video segment corresponding to the video comments.

4. The method according to claim 1, wherein the playing duration is a preset duration, or a preset proportion of a total duration of the online video.

5. An electronic device, comprising:
at least one processor; and
a memory communicably connected with the at least one processor for storing instructions executable by the at least one processor, wherein execution of the instructions by the at least one processor causes the at least one processor to:
for an online video, determine playing starting time of an effective video segment according to occurrence time of video comments and the number of occurrences of the video comments during playing of the online video;
obtain the effective video segment according to the playing starting time of the effective video segment and a playing duration of the effective video segment;
present the effective video segment in a video segment list of the online video.

6. The electronic device according to claim 5, wherein the step to determine playing starting time of an effective video segment according to occurrence time of video comments and the number of occurrences of the video comments during playing of the online video comprises:
marking timestamps of the video comments;
obtaining playing starting time of the video segment corresponding to the video comments according to the timestamps;
obtaining the playing starting time of the effective video segment from the playing starting time of the video segment according to the number of the video comments at the playing starting time.

7. The electronic device according to claim 6, wherein the step to obtain playing starting time of the video segment corresponding to the video comments according to the timestamps comprises: subtracting the timestamps by preset time to obtain the playing starting time of the video segment corresponding to the video comments.

8. The electronic device according to claim 5, wherein the playing duration is a preset duration, or a preset proportion of a total duration of the online video.

9. A non-transitory computer-readable medium, storing executable instructions that, when executed by an electronic device, cause the electronic device to:
for an online video, determine playing starting time of an effective video segment according to occurrence time of video comments and the number of occurrences of the video comments during playing of the online video;
obtain the effective video segment according to the playing starting time of the effective video segment and a playing duration of the effective video segment;
present the effective video segment in a video segment list of the online video.

10. The non-transitory computer-readable medium according to claim 9, wherein the step to determine the playing starting time of the effective video segment according to the occurrence time of the video comments and the number of occurrences of the video comments during playing of the online video comprises:
marking timestamps of the video comments;
obtaining playing starting time of the video segment corresponding to the video comments according to the timestamps;
obtaining the playing starting time of the effective video segment from the playing starting time of the video segment according to the number of the video comments at the playing starting time.

11. The non-transitory computer-readable medium according to claim 10, wherein the step to obtain the playing starting time of the video segment corresponding to the video comments according to the timestamps comprises:
subtracting the timestamps by preset time to obtain the playing starting time of the video segment corresponding to the video comments.

12. The non-transitory computer-readable medium according to claim 9, wherein the playing duration is a preset duration, or a preset proportion of a total duration of the online video.
